(19) United States
(12) Patent Application Publication
(10) Pub. No.: US 2016/0335637 A1
(43) Pub. Date: Nov. 17, 2016

(54) Systems and Methods for Facilitating Transactions to Payment Accounts, Via SMS Messaging

(71) Applicant: MASTERCARD INTERNATIONAL INCORPORATED, Purchase, NY (US)

(72) Inventors: Rahul A. Deshpande, Chesterfield, MO (US); Deborah E. Barta, Wildwood, MO (US); Nevada Alpine Kent, V, St. Louis, MO (US); Siddique Hameed, Chesterfield, MO (US); Stewart J. Boling, Chesterfield, MO (US); Michael K. Forbis, St. Louis, MO (US)

(21) Appl. No.: 15/150,839

(22) Filed: May 10, 2016

Related U.S. Application Data
(60) Provisional application No. 62/159,640, filed on May 11, 2015.

(51) Int. Cl. G06Q 20/40; H04W 4/14; G06Q 20/10

(52) U.S. Cl. CPC G06Q 20/4012; G06Q 20/102; H04W 4/14

(57) ABSTRACT

Systems and methods are provided for processing transactions to payment accounts. One exemplary method includes receiving a transaction request from a merchant relating to a transaction between a consumer and the merchant, transmitting a verification message to the merchant including a verification code, and receiving a verified transaction request from the merchant. At least one of the transaction request and the verified transaction request includes a telephone number associated with the consumer and an amount of the transaction. The method also includes transmitting a confirmation request to the consumer including a confirmation code, when the verified transaction request includes said verification code. The method further includes receiving a confirmation response from the consumer and transmitting an authorization request for the transaction, when the confirmation response includes said confirmation code.

### CROSS-REFERENCE TO RELATED APPLICATION

This application claims the benefit of, and priority to, U.S. Provisional Application No. 62/159,640 filed on May 11, 2015. The entire disclosure of the above application is incorporated herein by reference.

### FIELD

The present disclosure generally relates to systems and methods for facilitating transactions to payment accounts, and in particular, to systems and methods for facilitating such payment account transactions via SMS (short message service) messaging.

### BACKGROUND

This section provides background information related to the present disclosure which is not necessarily prior art.

Purchases of products, e.g., goods and services, are often funded through transactions to payment accounts. In general, the transactions are coordinated through merchants (offering the products for purchase), acquirers associated with the merchants, one or more service providers (or payment network interchanges), and issuers of the payment accounts. Separately, consumers are known to use SMS (short message service) messaging, commonly referred to as text messaging, to communicate information to other persons and/or entities.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating payment account transactions, via SMS messaging;

FIG. 2 is a block diagram of a computing device that may be used in the exemplary system of FIG. 1;

FIG. 3 is an exemplary method, suitable for use with the system of FIG. 1, for registering a consumer to a message transaction host in connection with facilitating a payment account transaction on behalf of the consumer;

FIG. 4 an exemplary method, suitable for use with the system of FIG. 1, for registering a merchant to the message transaction host;

FIG. 5 is an exemplary method, suitable for use with the system of FIG. 1, for facilitating a payment account transaction, via SMS messaging; and

FIG. 6 includes multiple exemplary interfaces that may be displayed, at portable communication devices, in connection with the system of FIG. 1 and/or the methods of FIGS. 3-5.

Corresponding reference numerals indicate corresponding parts throughout the several views of the drawings.

### DETAILED DESCRIPTION

The description and specific examples included herein are intended for purposes of illustration only and are not intended to limit the scope of the present disclosure. The description and specific examples included herein are intended for purposes of illustration only and are not intended to limit the scope of the present disclosure.

To use payment accounts to fund transactions, merchants must have the ability of verify the payment accounts, and to communicate the transactions to one or more entities responsible for processing the transactions (e.g., acquirers, payment networks, issuers, etc.). Generally, point of sale (POS) devices (e.g., card readers, etc.) collect payment account information from payment devices, and generate authorization requests, which are automatically transmitted, via the acquirers and the payment networks, to the issuers of the payment accounts, which then approve or decline the transactions. Depending on the size, location, sophistication, etc. of the merchants, POS devices suitable for payment account transactions may not be available, largely leaving merchants/consumers with only the option of paying with cash or check. The systems and methods described herein rely on short message service (SMS) messaging to provide data transmissions in connection with payment account transactions, including authorization (and/or confirmation) thereof, whereby the payment account transactions may be completed. In this manner, merchants are able to accept payment account transactions, without investment in POS devices, and often regardless of the location, size and/or sophistication of the merchants.

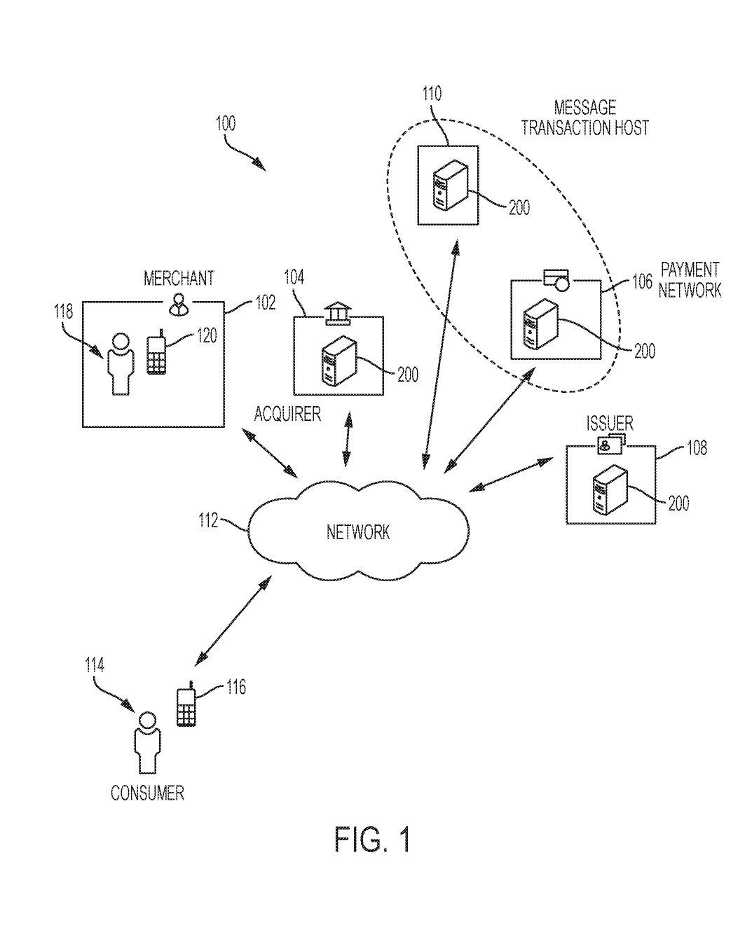

FIG. 1 illustrates an exemplary system 100, in which the one or more aspects of the present disclosure may be implemented. Although, in the described embodiment, the system 100 is presented in one arrangement, other embodiments may include the system 100 arranged otherwise, depending, for example, on processes for payment transactions, consumer-merchant interactions, etc.

The system 100 generally includes a merchant 102, an acquirer 104, a payment network 106, an issuer 108, and a message transaction host 110, each coupled to (and in communication with) network 112. The network 112 may include, without limitation, a local area network (LAN), a wide area network (WAN) (e.g., the Internet, etc.), a mobile network, and/or another suitable public and/or private network capable of supporting communication among two or more of the components illustrated in FIG. 1, or any combinations thereof. For example, network 112 may include multiple different networks, such as a private payment transaction network made accessible by the payment network 106 to the acquirer 104 and the issuer 108, and separately, a telecommunications network, through which the message transaction host 110 transmits/receives SMS messages to/from the merchant 102 and/or consumer 114, via portable communication devices 116, 120, etc.

As shown in FIG. 1, in this embodiment, the merchant 102 includes a sales person 118, who is associated with portable communication device 120, such as, for example, a mobile phone, etc. The sales person 118 is associated with the merchant 102, and may include, for example, an owner, employee, checkout clerk, sales associate, service person, worker, etc., who (is affiliated with merchant 102 and) aids consumer 114 in the purchase of products offered for purchase, or performs or causes to be performed the service(s), for which the consumer 114 is paying, and/or any other person associated with the merchant 102 and involved in the transaction, etc. The portable communication device 120 is configured to exchange SMS messages with other devices, and in particular, the message transaction host 110.

The consumer 114, on the other hand, interacts with the merchant 102 to purchase products. The consumer 114, as shown, is also associated with portable communication device 116 (also configured to exchange SMS messages with other devices). Each of the consumer 114 and the merchant 102 is registered to the message transaction host 110, so that SMS messages from the portable communication devices 116, 120 are identified to the respective consumer 114 or merchant 102 (e.g., based on the telephone number associated with the particular portable communication device 116, 120; etc.). The registration further includes the association of a payment account, with the consumer 114, with which the consumer 114 expects to fund transactions, and the association of an account (e.g., bank account, payment account, etc.) with the merchant 102, with which the merchant 102 expects to receive funds for the consumer's purchases.

While only one merchant 102 (and one communication device 120 associated therewith) and one consumer 114 (and one communication device 116 associated therewith) are illustrated in FIG. 1, it should be appreciated that any number of merchants and/or consumers (and/or associated communication devices), as described herein, may be included in different embodiments.

Likewise, a different number of acquirers, payment networks, and/or issuers may be included. For example, different merchants (not shown) may have one or more different acquirers, and different consumers (not shown) may employ payment accounts issued by one or more different issuers.

As shown in FIG. 1, the message transaction host 110 is generally associated with and/or integrated with the payment network 106 (as indicated by the dotted lines). Nonetheless, it should be understood that the message transaction host 110 may be integrated with the acquirer 104, or with the issuer 108 in other embodiments. In still other embodiments, the message transaction host 110 may be a stand-alone entity, which interacts with the merchant 102, the acquirer 104, the payment network 106, the issuer 108, and/or the consumer 114 to perform as described herein. And, in at least one embodiment, the message transaction host 110 is provided at the merchant-level, whereby the message transaction host 110 provides the capabilities of payment account transactions to multiple merchants, which are commonly owned, commonly branded, or otherwise associated.

The message transaction host 110 is generally configured to provide payment account transactions to the payment network 106, via SMS messaging. In particular, when the consumer 114 attempts a transaction at merchant 102, the sales person 118, via the portable communication device 120, transmits a SMS message (i.e., a transaction request) to the message transaction host 110. The message transaction host 110, in turn, receives the transaction request, including the consumer's telephone number, and transmits a verification message, via SMS, to the consumer 114. The consumer 114, via the portable communication device 116, transmits a confirmation response (approving or declining the transaction), via SMS, back to the message transaction host 110. In turn, the message transaction host 110 transmits an approval/decline message, via SMS, to the merchant 102, and in particular, the sales person 118 (at portable communication device 120) indicting the approval or decline of the transaction. It should be appreciated that various additional messages and/or message contents (e.g., codes, etc.) may be exchanged between the merchant 102, the message transaction host 110, and the consumer 114, to provide, for example, verifications, authorizations, and confirmations, etc., in connection with the transaction.

Once the transaction is approved by the consumer 114, prior to informing the merchant 102, the message transaction host 110 causes the transaction to be processed to the consumer's payment account and/or the merchant's account, by coordinating with the acquirer 104 (i.e., holder of the merchant's account), payment network 106, and/or the issuer 108 (i.e., holder of the consumer's account), as necessary. For example, the message transaction host 110, prior to or after seeking approval from the consumer 114, may submit an authorization request to the issuer 108 (i.e., the issuer of the payment account associated with the consumer 114) via the payment network 106 (e.g., via MasterCard®, VISA®, Discover®, American Express®, etc.) to determine whether the payment account is in good standing and whether sufficient credit/funds exist to complete the transaction. The authorization request generally includes the payment account number, a merchant ID, and an amount of the transaction. In certain embodiments, the authorization request may include other information, such as, for example, a time/date, a PIN, a ZIP code, or other information (including verification information) received from the consumer 114 and/or merchant 102 regarding the transaction or otherwise, or appended by the message transaction host 110. The issuer 108, in turn, responds to the authorization request (i.e., approving or declining), to the message transaction host 110, via the payment network 106, which permits the message transaction host 110 to proceed as described above.

After the transaction is approved (and completed between the merchant 102 and consumer 114), the message transaction host 110 may further participate in clearing and/or settlement of the transaction by and between the merchant 102, the acquirer 104, and the issuer 108.

Transaction data is generated, collected, and stored as part of the above interactions among the merchant 102, the acquirer 104, the payment network 106, the issuer 108, and the message transaction host 110. The transaction data represents at least a plurality of transactions, e.g., completed transactions, attempted transactions, etc. The transaction data, in this exemplary embodiment, is stored by (or at) at least one of: the message transaction host 110 and the payment network 106, in a data structure associated therewith, depending on the particular embodiment, etc. Additionally, or alternatively, the merchant 102, the acquirer 104, and/or the issuer 108 may store the transaction data, or part thereof, in memory. The transaction data may include, for example, payment account numbers, amounts of the transactions, consumer IDs, merchant IDs, merchant category codes, dates/times of the transactions, product identifiers, transaction numbers, etc. It should be appreciated that more or less information related to processing, approving, and/or declining transactions may be included in transaction data and stored within the system 100, at the message transaction host 110, the acquirer 104, the payment network 106, and/or the issuer 108.

In various exemplary embodiments, consumers (e.g., consumer 114, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

Each of the merchant 102, the acquirer 104, the payment network 106, the issuer 108, and the message transaction host 110, in the exemplary embodiment of FIG. 1, may be implemented in one or more computing devices, such as a computing device or multiple computing devices located together, or distributed across a geographic region. Further, in this exemplary embodiment, the portable communication devices 116, 120 associated with the consumer 114 and the sales person 118 of the merchant 102 may further be implemented as a computing device. The computing device may include, for example, one or more mobile phones, feature phones, smartphones, servers, computers, laptops, tablets, personal navigation devices, etc. For illustration, computing device 200 is described herein. The system 100, however, should not be considered to be limited to the computing device 200, as different computing devices and/or arrangements of computing devices may be used in other embodiments.

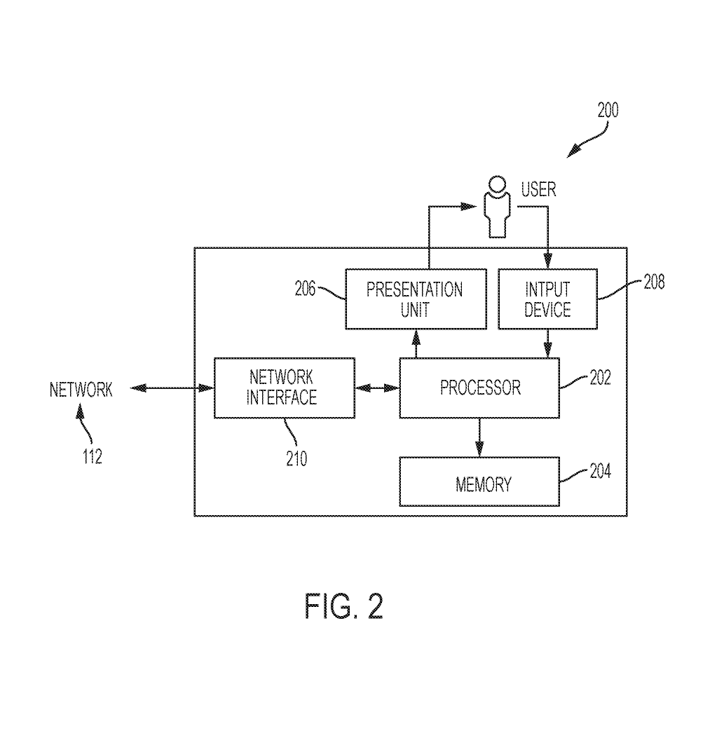

Referring to FIG. 2, the exemplary computing device 200 includes a processor 202 and a memory 204 coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, flash drives, hard disks, and/or any other type of volatile or nonvolatile physical or tangible computer-readable media. Memory 204 may be configured to store, without limitation, transaction data, payment account numbers, phone numbers, consumer profiles, clearing and/or settlement logs, transaction numbers, verification numbers, PINs, and/or other types of data suitable for use as described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., SMS messages, etc.), either visually or audibly, to the user, for example, the consumer 114, the sales person 118, etc. It should be further appreciated that various interfaces (e.g., screens, etc.) may be displayed at computing device 200, and in particular at presentation unit 206, to display information, such as, for example, SMS messages, etc. The presentation unit 206 may include, without limitation, a liquid crystal display (LCD), a light-emitting diode (LED) display, an organic LED (OLED) display, and/or an “electronic ink” display, etc. In some embodiments, presentation unit 206 includes multiple devices.

The computing device 200 also includes an input device 208 that receives inputs from the user (i.e., user inputs) such as, for example, message typing, send commands, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both presentation unit 206 and input device 208.

In addition, the illustrated computing device 200 also includes a network interface 210 coupled to (and in communication with) the processor 202 and the memory 204. The network interface 210 may include, without limitation, a wired network adapter, a wireless network adapter, a cellular network adapter, or other device capable of communicating to one or more different networks, including the network 112. Generally, in this exemplary embodiment, the network interface 210 is at least configured to transmit and receive SMS messages. Further, in some embodiments, the computing device 200 includes the processor 202 and one or more network interfaces incorporated into or with the processor 202.

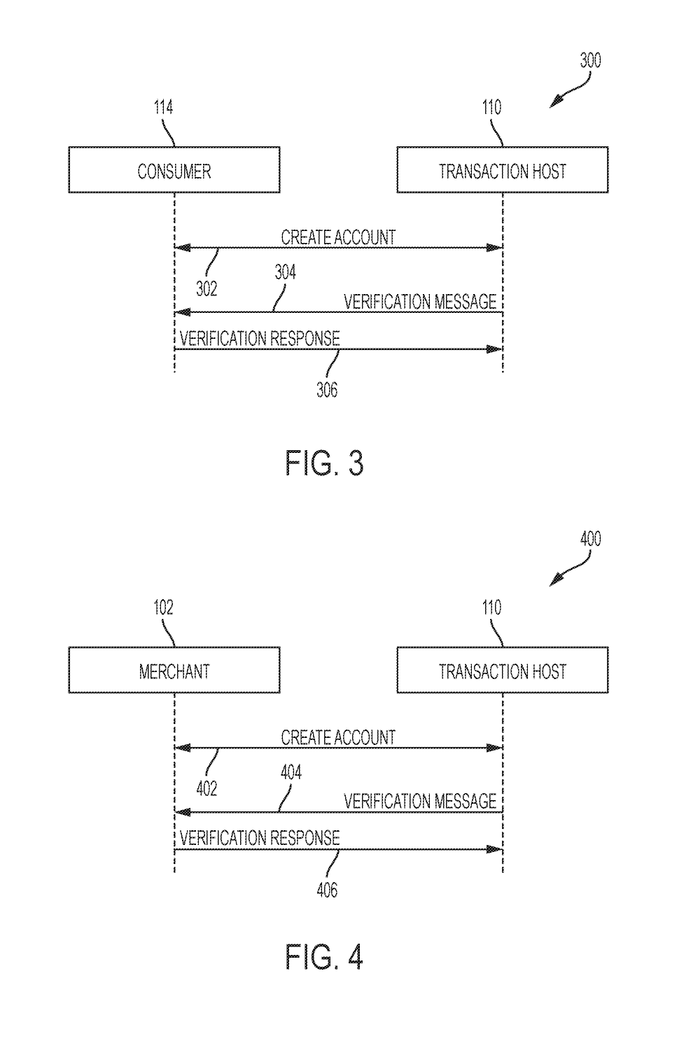

FIG. 3 illustrates an exemplary method 300 that can be used in the system 100 of FIG. 1 for registering the consumer 114 to the message transaction host 110. The exemplary method 300, like methods 400 and 500 described below, are presented with reference to the system 100, and the computing device 200. It should be appreciated, however, that the various methods (and systems and computing devices) described herein are not limited to the system 100 or the computing device 200, as other different systems and devices may be included in other embodiments. Likewise, the systems and methods described herein should not be understood to be limited to methods 300, 400, or 500, alone or in combination.

As shown in FIG. 3, to register in the method 300, the consumer 114 initially creates an account with the message transaction host 110, at 302. The consumer's account may be created through SMS messages between the consumer 114 and the message transaction host 110, whereby the SMS messages are exchanged to permit the message transaction host 110 to collect information from the consumer 114. Such information may include, without limitation, identifying information relating to the consumer 114 (e.g., name, address, identifier (ID) numbers, birthdate, etc.), payment account number(s) for the consumer's payment account(s) to be used in any transactions processed via the message transaction host 110, telephone number(s), etc. In so doing, the consumer's payment account is linked to the consumer's telephone number (e.g., in a data structure associated with the message transaction host 110, in another data structure, etc.), so that the payment account can be used by presenting the telephone number, as described hereinafter. In other embodiments, the message transaction host 110 may provide a website or application, through which the consumer 114 may create an account with the message transaction host 110. In at least one embodiment, the consumer's account is created as the result of a voice call between the consumer 114 and a user (or automated system) associated with the message transaction host 110. Despite the particular examples above, it should be appreciated that communication between the message transaction host 110 and the consumer 114 may be accomplished in any manner to create an account, for use as described herein.

Once the account is created, it is generally verified by the message transaction host 110. As shown in FIG. 3, the message transaction host 110 sends, via computing device 200 associated therewith, a verification message, via SMS (or otherwise), to the consumer 114, at 304. The verification message includes a verification code, associated with the consumer 114 and/or the created account (e.g., as associated with the payment account number, etc.). The verification code may be generated and/or assigned to the consumer 114 by the message transaction host 110, or by another, for example, in response to the interactions with the message transaction host 110. In turn, to complete registration to the message transaction host 110, the consumer 114 provides a verification response (including the verification code) back to the message transaction host 110, at 306. The verification response may be accomplished, for example, by transmitting, via SMS message, the verification code from the consumer's portable communication device 116 to the message transaction host 110. Alternatively, in another example, the consumer 114 may enter the verification code at a website, application, or other web-based platform associated with (or provided by) the message transaction host 110. It should be appreciated that still other manners may be employed to provide the verification code back to the message transaction host 110 (e.g., via a voice call, email, etc.). Upon receipt of the verification code at the computing device associated with the message transaction host 110, the message transaction host 110 completes the registration of the consumer 114, stores the account in memory (e.g., memory 204, etc.), and designates the account as active for transactions.

FIG. 4 illustrates exemplary method 400 that can be used in the system 100 of FIG. 1 for registering the merchant 102 to the message transaction host 110.

As shown, the merchant 102 creates an account with the message transaction host 110, at 402. As described above with reference to FIG. 3, the merchant account may be created via SMS messages between the merchant 102 and the message transaction host 110, a website or application provided by the message transaction host 110, voice calls, or in other manners. When the merchant 102 creates the account, however, in addition to providing a telephone number, rather than providing a payment account from which funds are generally debited or charged, the merchant 102 provides a merchant account, which generally receives the funds for purchases at the merchant 102. Merchant accounts may include a variety of different accounts, including, without limitation, bank accounts, payment accounts, etc. By creating the account, the merchant's account is linked to the merchant's telephone number, so that the payment account transactions to the merchant account may be initiated by the portable communication device 120 of the merchant 102 (and in particular, the sales person 118). For example, when the message transaction host 110 receive a transaction request from the merchant 102, based on the originating telephone number of the message (i.e., the merchant's registered telephone number), the message transaction host 110 is able to identify the merchant 102 (without the merchant 102 providing identifying information in the transaction request).

Once the merchant 102 has created the account, at 402, the message transaction host 110 sends a verification message, via SMS (or otherwise), to the merchant 102 (and, in particular to the portable communication device 120), at 404. The SMS message includes a verification code, associated with the merchant 102 and/or the created account (e.g., with the merchant's the account number, etc.). In turn, to complete the registration, the merchant 102 provides the verification code back to the message transaction host 110, at 406. As indicated above, the verification code may be provided back to the transaction host 110, for example, via SMS messaging, via a website, application, or other web-based platforms associated with (or provided by) the message transaction host 110, via a voice call, and/or via email, etc. Upon receipt of the verification code at the computing device associated with the message transaction host 110, the message transaction host 110 completes the registration of the merchant 102, stores the account in memory (e.g., memory 204, etc.), and designates the account as active for transactions.

It should be appreciated that numerous variations may be employed in the registrations of the consumer 114 and/or the merchant 102 in other embodiments, depending on, for example, the information collected by the message transaction host 110, any variation to the system 100, the types of accounts involved in the registration, additional and/or alternative security measures, etc.

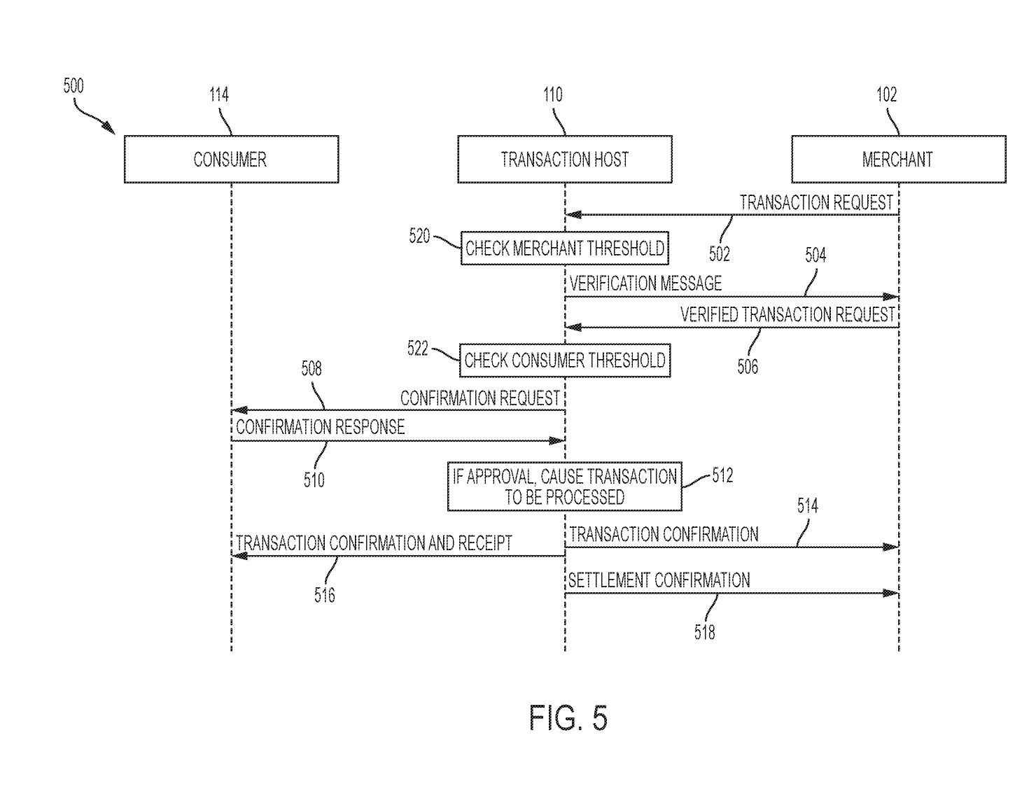

FIG. 5 illustrates a method 500 of processing a transaction to a payment account, via SMS messaging, involving the registered consumer 114 and registered merchant 102. When the consumer 114 decides to purchase a product at the merchant 102, the merchant 102, at 502, transmits a transaction request, via SMS, by the portable communication device 120, to the message transaction host 110. The request may include information about the transaction (e.g., an amount of the transaction, etc.), or may be non-specific to the transaction. In response, the message transaction host 110 receives the request, at associated computing device 200, and identifies the merchant 102, for example, based on the originating phone number of the SMS message. The message transaction host 110 then transmits, at 504, a verification message, via SMS, to the merchant 102. The verification message includes a verification code, which may be a transaction identifier for the impending transaction, or alternatively, unrelated to the transaction, etc. In this exemplary embodiment, the merchant 102 receives the verification message, and then, at 506, transmits, via SMS, by the portable communication device 116, a verified transaction request to the message transaction host 110. The verified transaction request includes the verification code provided by the message transaction host 110. In this manner, the transaction request, at 506, is verified (i.e., is the verified transaction request).

Additionally, if the initial transaction request at 502 did not include transaction specific information, the verified transaction request at 506 will include this information. The transaction specific information may include, for example, the telephone number of the consumer 114, the amount of the transaction, etc. Other information may be included regarding the product, the consumer 114, and/or the merchant 102, as desired.

It should be appreciated that a verification code in the method 500 (as well as in methods 300 and 400) may be time sensitive, i.e., it may be only valid for a predefined interval. Specifically, for example, the verification code may expire after 10 seconds, 1 minute, 5 minutes, or 10 minutes, or another suitable interval, etc. Further, the verification code may be valid for only one transaction. Further still, the verification code may be a unique number, as compared to prior verification codes sent to the merchant 102, and/or may be randomly generated by the message transaction host 110, such that the verification code is at least different than any prior verification code transmitted to the merchant 102 in the last day, week, month, or year, etc. In certain instances, the receipt and transmittal of the time-sensitive, one-use verification code in the method 500 provides a measure of security to the transaction (e.g., to help combat telephone number spoofing devices, etc.).

With continued reference to FIG. 5, the message transaction host 110, in response to the verified transaction request at 506, transmits, at 508, via computing device 200, a confirmation request to the consumer 114, via SMS, to the portable communication device 116 associated with the consumer 114, i.e., the telephone number included in the transaction request and also registered to the consumers' payment account. The confirmation request includes, in this embodiment, an approval code, and potentially one or more details about the transaction (e.g., the merchant name, amount of the transaction, etc.). In turn, the consumer 114 transmits, at 510, a confirmation response, by the portable communication device 116, via SMS, to the message transaction host 110. The confirmation response, if an approval by the consumer 114, is a confirmation of the consumer's permission to charge the transaction to the payment account linked to the telephone number of the portable communication device 116. The approval confirmation response includes the confirmation or approval code provided by the message transaction host 110. The approval code may vary in length and/or complexity in various embodiments. For example, the confirmation request may provide a simple approval code: “Y” or “1” to approve the transaction, and “N” or “0” to decline the transaction. Or, it may be more complex. Regardless of the particular form and/or format of the code, a lack of a confirmation response (after a predefine interval (e.g., 1 minute, 3 minutes, 5 minutes, etc.)), in several embodiments, would be understood as a decline. Alternatively, in several embodiments, the consumer 114 may be prompted to respond (with or without the approval code) with a PIN or password associated with the portable communication device 116 or payment account (or by other means to authenticate the consumer 114 and/or the communication device 116). It should be appreciated that a variety of different messages, contents, numbers, etc., may be used to ensure secure posting of transactions to the consumer's payment account, as described herein. Again, however, because the message transaction host 110 provides the confirmation code, and the consumer 114 responds with the confirmation code (when approving the transaction), or a PIN or other information private to the consumer 114, the method 500 provides a measure of security to the transaction.

Upon receipt of the confirmation response from the consumer 114 at 510, if an approval, the message transaction host 110 causes the transaction to be processed to the consumer's payment account (i.e., the payment account linked to the consumer's telephone number during registration with the message transaction host 110), at 512. Specifically, the message transaction host 110 (depending on where in the system 100 it is located and/or integrated), transmits an authorization request to the issuer 108 (via, for example, the acquirer 104, payment network 106, etc., as necessary).

Prior to transmitting the authorization request, the message transaction host 110 retrieves the payment account number associated with the consumer's payment account, based on the telephone number included in the transaction request received from the merchant 102 (in the initial or verified transaction request). The authorization request includes the payment account (determined based on the consumer's telephone number), the amount of the transaction, a merchant ID, a merchant account number, the acquirer ID, etc. As described above in connection with the system 100, in response, the issuer 108 verifies the payment account, and provides an authorization response, which approves or declines the transaction. The message transaction host 110 receives the authorization response, and at 514, transmits a transaction conformation, including an approval or decline of the transaction, to the portable communication device 120 associated with the merchant 102. The merchant 102 then either completes the purchase with the consumer 114, when approved by the issuer 108, or acts accordingly when the transaction is declined (e.g., requests a different form of payment from the consumer 114, etc.). When the authorization response approves the transaction, in this exemplary embodiment, a transaction confirmation and receipt is also transmitted by the message transaction host 110, at 516, to the portable communication device 116 associated with the consumer 114.

Finally, in this exemplary embodiment, at 518, the message transaction host 110 sends settlement, by way of a settlement confirmation, to the merchant 102. Settlement may be accomplished immediately by causing funds to be added/deposited to the merchant's account, or alternatively, settlement may be accomplished at the end of the business day, or within a predefined interval (e.g., 24 hours, 48 hours, etc.). Regardless of the manner of settlement, in this exemplary embodiment, the acquirer 104 submits the request for settlement to the payment network 106, which in turn, issues a credit to the acquirer 104 (and specifically, the merchant account) and a debit to the issuer 108 (and specifically, the consumer's payment account), i.e., the payment network 106 effects settlement. In one or more other embodiments, the acquirer 104 and the issuer 108 may interact directly, or otherwise, to avoid the payment network 106.

In one or more embodiments, the message transaction host 110 may employ one or more velocity thresholds relating to prior transactions (i.e., transaction history) (alone or in combination with the requested transaction), and various transaction limits or restrictions, involving the merchant 102. For example, as illustrated in FIG. 5, when the merchant 102 transmits the initial request, at 502, the message transaction host 110 may identify the merchant 102, based on the originating telephone number of the initial request, and then may analyze, at 520, the transaction data for the merchant 102 over the last hour, last day, last week, or other time interval, etc., and determine if a total number of transactions and/or dollar value of transactions at the merchant 102 exceeds a velocity threshold for the merchant 102, i.e., a merchant threshold. For example, the merchant 102 may be limited to 30 transactions per day, or 15 transactions per hour, or $500 in transactions per hour, or $2500 in transactions per day. Such a threshold may be imposed by the message transaction host 110, and/or the merchant 102, and/or the acquirer 104, to protect against automated and/or unauthorized transaction activity to the merchant account. One or more of the velocity thresholds may be explained to the merchant 102 during registration. In one or more embodiments, the merchant 102 may select or request a particular threshold during registration (or after). If the threshold is exceeded, at 520, regardless of how the threshold is established (by the message transaction host 110 or the merchant 102), the message transaction host 110 may decline to further facilitate the transaction.

Similarly, transactions to the consumer's payment account, via the message transaction host 110, may be subject to one or more velocity thresholds as well. As shown in FIG. 5, prior to transmitting the confirmation request to the consumer 114, at 508, the message transaction host 110 may identify the consumer 114 based on the telephone number received from the merchant 102, and then may analyze, at 522, the transaction data for the consumer 114 over the last hour, last day, or other time interval, etc. (i.e., transaction history) (alone or in combination with the requested transaction), and determine if a total number of transactions and/or dollar value of transactions exceeds a velocity threshold for the consumer 114, i.e., a consumer threshold. The threshold may be, for example, 5 transactions per hour, or only approved transactions for less than $35.00. The consumer 114 may agree to and/or select or request the thresholds during the registration of the account (or after). It should be appreciated that a variety of different thresholds may be employed to provide security to the use of SMS messaging, and the message transaction host 110, to complete payment account transactions. In the method 500, if the consumer threshold is exceeded, at 522, the message transaction host 110 may decline to further facilitate the transaction (i.e., decline to send the confirmation request at 508, or simply send a decline message, at 508, to the consumer 114, etc.).

It should be appreciated that as transaction data and other information is compiled for the consumer 114 and/or the merchant 102, various additional (or alternative) criteria may be employed to permit or decline transactions, as illustrated, for example, in FIG. 5.

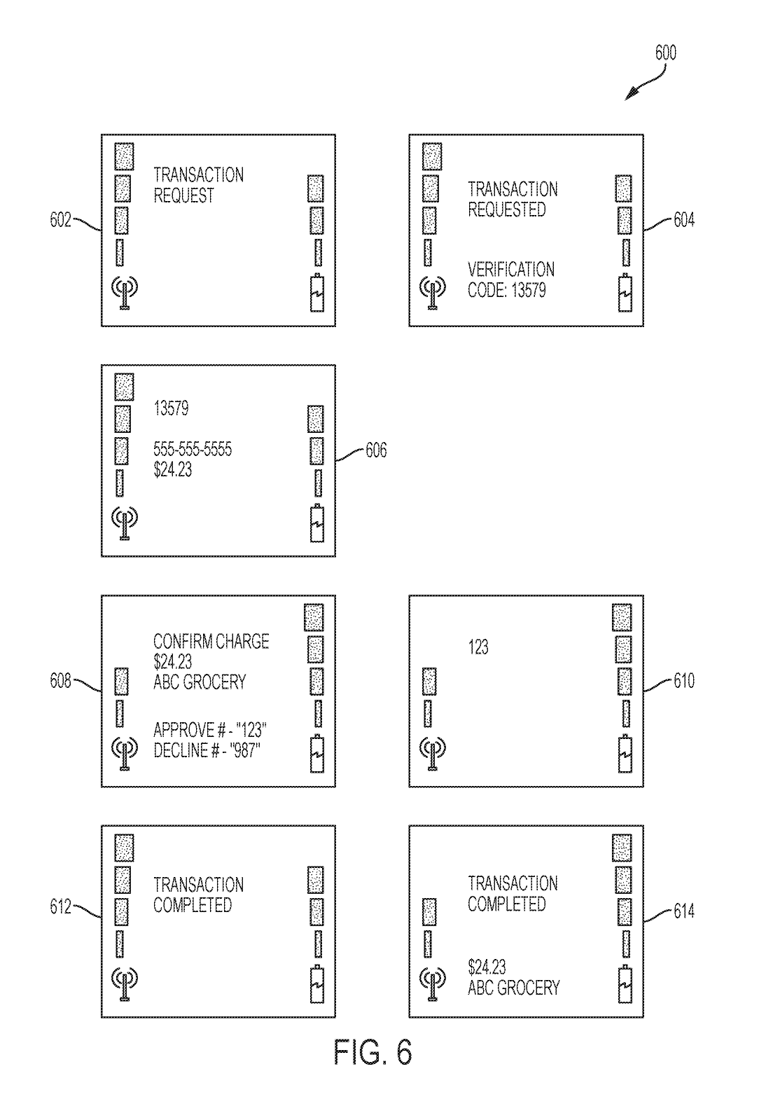

FIG. 6 illustrates a chain of exemplary messages 600 generated by and/or displayed to the consumer 114 and/or the merchant 102, at the portable communication devices 116, 120, in connection with the systems and methods herein. Specifically, the interface 602 includes the message “transaction request” sent by the merchant 102 to initiate a payment account transaction (e.g., at 502 in method 500, etc.). After the request, the portable communication device 120 receives and displays a verification message from the message transaction host 110, at interface 604 (e.g., at 504 in method 500, etc.). As shown, the verification message acknowledges that a transaction has been requested, and further includes a verification code (i.e., “13579”). In response, the merchant 102 (and in particular, the sales person 118), in this embodiment, enters, into a reply message (or transaction request), the verification code “13579”, the telephone number of the consumer 114, and the transaction amount or “TA” (i.e.., $24.23), as shown in the exemplary interface 606 (e.g., at 506 in method 500, etc.).

In response to the transaction request, at interface 602, the message transaction host 110 transmits a confirmation request to the consumer 114, and in particular, the portable communication device 116, for example, as shown at interface 608 (e.g., at 508 in method 500, etc.). The interface 608 includes a request to confirm a charge of “$24.34” to the merchant “ABC Grocery.” The message further includes a code to approve (i.e., 123) and a code to decline (i.e., 987) the transaction. As shown in interface 610, the consumer 114, in this example, enters “123” to approve the transaction and transmits it, via SMS, to the message transaction host 110 (e.g., at 510 in method 500, etc.).

In response to the approve code “123,” in the chain of exemplary messages in FIG. 6, the message transaction host 110 transmits an authorization request to the acquirer 104, payment network 106 and/or issuer 108, as necessary. Upon receipt of an approved response (e.g., from the issuer 108 of the payment account, directly or indirectly), the message transaction host 110 transmits the transaction confirmation indicating “transaction completed” shown in interface 612 to the merchant's portable communication device 120 (e.g., at 514 in method 500, etc.), and a transaction complete and receipt indicating “transaction completed” shown in interface 614 and identifying the merchant and amount of the charge to the consumer's portable communication device 116 (e.g., at 516 in method 500, etc.). It should be appreciated that the messages included in the interfaces 602-614 of FIG. 6 are merely exemplary, and that any different interfaces (and/or messages) may be exchanged between the consumer 114, the merchant 102, and the message transaction host 110 to facilitate and/or complete one or more payment account transactions.

It should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a transaction request from a merchant relating to a transaction between a consumer and the merchant; (b) transmitting a verification message to the merchant, the verification message including a verification code; (c) receiving a verified transaction request from the merchant, the verified transaction request including said verification code, and at least one of the transaction request and the verified transaction request including a telephone number associated with a consumer and an amount of the transaction; (d) transmitting a confirmation request to the consumer, the confirmation request including a confirmation code; (e) receiving a confirmation response from the consumer; (f) transmitting an authorization request for the transaction when the confirmation response includes said confirmation code; (g) retrieving a payment account number for the consumer from memory, based on the telephone number associated with the consumer; (h) receiving an authorization response, indicating the transaction is approved; (i) transmitting a first transaction confirmation to the merchant, and transmitting a second transaction confirmation to the consumer; (j) registering the merchant and the consumer; (k) correlating a phone number associated with the merchant to an account for the merchant, whereby funds can be added to the merchant's account during clearing and/or settlement of the transaction; (l) correlating the phone number associated with the consumer to a payment account for the consumer, whereby funds can be debited from the consumer's account during clearing and/or settlement of the transaction; or any other method operations, as recited in the claims below, or the description above.

It should be further understood that each computing device, or component illustrated in FIG. 1, for example, may include multiple computing devices. Specifically, for example, the message transaction host may include multiple different computing devices, one or more of which may generate verification codes, check velocity thresholds, etc., and other(s) of which may transmit/receive SMS messaging ,via one or more telecommunication network (e.g., a part of network 112, etc.). In such instances, former computing devices may be said to cause the later computing devices to transmit or receive SMS messaging, as described herein. Further, such different computing devices may be located together, or distributed across a geographic region.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, or associated with, or in communication with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of facilitating a transaction to a payment account, the method comprising:
receiving a transaction request from a merchant relating to a transaction between a consumer and the merchant;
transmitting a verification message to the merchant, the verification message including a verification code;
receiving, at a computing device, a verified transaction request from the merchant, the verified transaction request including said verification code, and at least one of the transaction request and the verified transaction request including a telephone number associated with the consumer and an amount of the transaction;
transmitting, by the computing device, a confirmation request to the consumer, the confirmation request including a confirmation code;
receiving a confirmation response from the consumer; and
transmitting an authorization request for the transaction when the confirmation response includes said confirmation code.

2. The method of claim 1, wherein the transaction request, from the merchant, includes the amount of the transaction and the telephone number associated with the consumer, the telephone number further associated with a payment account of the consumer; and
wherein the verified transaction request, from the merchant, excludes the amount of the transaction and the telephone number associated with the consumer.

3. The method of claim 1, wherein transmitting a confirmation request to the consumer includes:
determining if the transaction represented by the transaction request and/or prior transactions involving the consumer exceed a velocity threshold for the consumer;
transmitting the confirmation request, only when the consumer velocity threshold is not exceeded; and
declining the transaction when the consumer velocity threshold is exceeded.

4. The method of claim 3, wherein transmitting a verification message to the merchant includes:
determining if the transaction represented by the transaction request and/or prior transactions to the merchant exceed a velocity threshold for the merchant;
transmitting the verification code, only when the merchant velocity threshold is not exceeded; and
declining the transaction when the merchant velocity threshold is exceeded.

5. The method of claim 4, wherein the verification code includes a randomly selected number, which is valid for at least 10 seconds, but not longer than 10 minutes.

6. The method of claim 1, wherein transmitting an authorization request for the transaction includes transmitting the authorization request to a payment network and/or an issuer of a payment account of the consumer.

7. The method of claim 6, further comprising retrieving a payment account number for the consumer from memory, based on the telephone number associated with the consumer; and
wherein the authorization request includes the payment account number.

8. The method of claim 7, further comprising:
receiving an authorization response, indicating the transaction is approved; and
transmitting a first transaction confirmation to the merchant, and transmitting a second transaction confirmation to the consumer.

9. The method of claim 8, further comprising:
registering, by the computing device, the merchant and the consumer;
correlating, in memory associated with the computing device, a phone number associated with the merchant to an account for the merchant, whereby funds can be added to the merchant's account during clearing and/or settlement of the transaction; and
correlating, in memory associated with the computing device, the phone number associated with the consumer to a payment account for the consumer, whereby funds can be debited from the consumer's account during clearing and/or settlement of the transaction.

10. A system for facilitating payment account transactions, via short message service (SMS) messaging, the system comprising:
a network interface configured to transmit and/or receive one or more SMS messages to and/or from a network; and
a processor coupled to the network interface and configured to:
transmit a verification message to a merchant, in connection with a transaction between a consumer and the merchant, as a SMS message, the verification message including a verification code for the transaction;
transmit a confirmation request to the consumer as a SMS message when a reply to the verification message, from the merchant, includes the verification code, the confirmation request including a confirmation code for the transaction; and
cause an authorization request for the transaction to be generated when a reply to the confirmation request, from the consumer, includes said confirmation code.

11. The system of claim 10, wherein the processor is configured to transmit the verification message to the merchant based on an originating telephone number of a SMS transaction request generated by the merchant for the transaction; and
wherein the processor is configured to transmit the confirmation request to the consumer based on a phone number for the consumer included in the SMS transaction requested generated by the merchant and/or in the reply from the merchant to the verification message.

12. The system of claim 11, wherein the processor is configured to identify a payment account number of a payment account for the consumer, used in the transaction, based on the phone number associated with the consumer; and
wherein, in connection with causing an authorization request for the transaction to be generated, the processor is configured to cause the payment account number to be included in the authorization request.

13. The system of claim 11, further comprising a memory coupled to the processor, the processor further configured to:
correlate, in the memory, the phone number associated with the merchant to an account for the merchant, so that funds can be added to the merchant's account during clearing and/or settlement of the transaction based on the merchant's phone number; and
correlate, in the memory, the phone number associated with the consumer to a payment account for the consumer, so that funds can be debited from the consumer's account during clearing and/or settlement of the transaction based on the consumer's phone number.

14. The system of claim 11, wherein the processor is configured to cause the authorization request for the transaction to be generated when the reply to the confirmation request, from the consumer, includes a personal identification number (PIN) associated with the consumer.

15. The system of claim 14, wherein the processor is configured to transmit the verification message to the merchant, when the transaction and/or the merchant's transaction history does not exceed a merchant velocity threshold; and/or
wherein the processor is configured to transmit the confirmation request to the consumer, when the transaction and/or the consumer's transaction history does not exceed a consumer velocity threshold.

16. The system of claim 10, further comprising non-transitory computer readable storage media comprising executable instructions, which, when executed by a portable computing device, cause the portable computing device to:
transmit, to the processor, a transaction request for the transaction between the consumer and the merchant;
receive the verification message from the processor and receive an input of the verification code for the transaction, as included in the verification message; and
transmit a verified transaction request to the processor, as the reply to the verification message, including the verification code;
wherein at least one of the transaction request and the verified transaction request includes an amount of the transaction and a telephone number associated with the consumer.

17. The system of claim 10, wherein the processor is configured to transmit the confirmation request to the consumer, when said reply to the verification message is received within a predefined period of transmitting the verification message; and
wherein the processor is configured to cause the authorization request for the transaction to be generated when said reply to the confirmation request is received within a predefined period of transmitting the confirmation request.

18. A non-transitory computer readable storage media comprising executable instructions for facilitating a payment account transaction between a consumer and a merchant, which, when executed by a processor, cause the processor to:
transmit, to a messaging transaction host, by a portable communication device associated with a merchant, a transaction request for a transaction between a consumer and the merchant to a payment account associated with the consumer;
receive, at the portable communication device, a verification message from the messaging transaction host, the verification message associated with the transaction and including a verification code for the transaction; and
transmit, by the portable communication device, a verified transaction request to the messaging transaction host in response to the verification message;
wherein at least one of the transaction request and the verified transaction request includes an amount of the transaction and a telephone number associated with the consumer and/or the payment account associated with the consumer.

19. The non-transitory computer readable storage media of claim 18, wherein the executable instructions, when executed by the processor, further cause the processor to:
receive, at a portable communication device associated with the consumer, a confirmation request from the messaging transaction host when the verified transaction request includes the verification code, the confirmation request associated with the transaction and including a confirmation code for the transaction; and
transmit, by the portable communication device associated with the consumer, a confirmation response to the messaging transaction host in response to the confirmation request;
whereby an authorization request for the transaction is generated when the confirmation response includes said confirmation code.

20. The non-transitory computer readable storage media of claim 19, wherein each of the transaction request, the verification message, the verified transaction request, the confirmation request, and the confirmation response comprises a short message service (SMS) message.
